(19) United States
(12) Patent Application Publication
(10) Pub. No.: US 2013/0202101 A1
(43) Pub. Date: Aug. 8, 2013

(54) SYSTEM AND METHOD FOR MANUAL INITIATION OF COMMUNICATIONS TO MEMBERS OF A CONTACT LIST

(71) Applicants: Mark Alan LaBoyteaux, Carmel, IN (US); Adam Joseph Elkins, Indianapolis, IN (US); Corey David Bischoff, Batesville, IN (US); Jason Andrew Loucks, DeForest, WI (US)

(72) Inventors: Mark Alan LaBoyteaux, Carmel, IN (US); Adam Joseph Elkins, Indianapolis, IN (US); Corey David Bischoff, Batesville, IN (US); Jason Andrew Loucks, DeForest, WI (US)

(21) Appl. No.: 13/366,820

(22) Filed: Feb. 6, 2012

(51) Int. Cl. H04M 3/00

(52) U.S. Cl. 379/265.02

(57) ABSTRACT

Customer service agents within a communications handling center, such as a contact center handling telephone calls, are assigned to queues. One or more calling agents are also given rights to initiate calls through a manual dialing interface. In certain embodiments, these calling agents dial a telephone number by clicking a mouse on a designated button on a computer display. When a call is placed, if a live party is detected, the call will be routed to the next available customer service agent in the queue. As calls are initiated, the calling agent will see the number of calls connected and routed to customer service agents increase, and can compare this number to the total number of customer service agents available. By manually clicking to dial, the calling agent can manually place calls at a pace that will keep customer service agent occupancy at a maximum, without overflowing the queue.

### TECHNICAL FIELD OF THE DISCLOSED EMBODIMENTS

The present invention generally relates to telecommunications systems and methods and, more particularly, to systems and methods for dialing telephone numbers on a contact list.

### BACKGROUND OF THE DISCLOSED EMBODIMENTS

The Telephone Consumer Protection Act (TCPA) was originally passed by the U.S. Congress in 1991 as Public Law 102-243, amending the Communications Act of 1934. The current version of the statute is found principally at 47 U.S.C. §227. The TCPA is the primary law in the United States governing the conduct of telephone solicitations. Ever since its passage, companies with contact centers have needed to adjust their business practices to attempt to maintain various efficiencies while complying with the law.

The TCPA restricts the use of automatic dialing systems (also known as “autodialers”). Automatic dialing technology allows telephone calls to be placed without manual, or direct human, involvement. Typical autodialer systems dial a plurality of telephone numbers and send a subset of the plurality of dialed numbers to each agent in a group of agents designated to handle the calls. If more than one call at a time is sent to a specific agent, a queue may be established in which contacted persons are place on hold until the agent is available. Since the agent does not need to dial any of the telephone numbers for the calls he is handling, such typical autodialing systems allow agents to focus on speaking to customers rather than dialing telephone numbers.

The use of mobile telephones has become increasingly popular, especially over the last decade. Accordingly, many contact centers have used autodialer technologies to contact people on mobile telephones. The public, however, became frustrated with autodialer systems contacting them on their mobile telephones because in some instances this caused a charge to be incurred by the consumer for the airtime consumed by the call. In September 2009, the TCPA was thus amended to include a provision that prohibits autodialer calls to mobile telephones without express consumer consent.

One way that call centers can comply with the TCPA amendment is by having an agent dial each telephone number on the list of parties with whom the agent desires to speak and then wait to see if a person answers the call. It will be apparent to those skilled in the art that such a manually intensive process is far more costly than the previous autodialer systems. Accordingly, there is a need to meet the law's requirement that such calls include manual involvement in an efficient manner.

### SUMMARY OF THE DISCLOSED EMBODIMENTS

In accordance with the presently disclosed embodiments, customer service agents within a communications handling center, such as a contact center handling telephone calls, are assigned to queues. One or more calling agents are also given rights to initiate calls through a manual dialing interface. In certain embodiments, these calling agents dial a telephone number by clicking a mouse on a designated button on a computer display. Each time a click-to-dial is initiated, the next contact in a call list will be dialed. When a call is placed, call analysis can be performed, and if a live party is detected, the call will be routed to the next available customer service agent in the queue. This queue can also optionally assess customer service agent skills to ensure customer service agent skill requirements are met for the routed call. For each call placed, a disposition may be written to the call list according to the result. As calls are initiated, the calling agent will see the number of calls connected and routed to customer service agents increase, and can compare this number to the total number of customer service agents available. By manually clicking to dial, the calling agent can manually place calls at a pace that will keep customer service agent occupancy at a maximum, without overflowing the queue.

In one embodiment, in a contact center having a plurality of customer service agents for participating in communications, a method for initiating communications to members of a contact list is disclosed, the method comprising the steps of: a) selecting a first member from the contact list; b) displaying to a calling agent information about the first member; c) establishing a control that may be activated to initiate a communication with the first member; d) displaying to the calling agent data selected from the group consisting of: number of the plurality of customer service agents available, number of communications connected to any one of the plurality of customer service agents, number of communications waiting to be connected to any one of the plurality of customer service agents, a status of recently initiated communications, and a number of members on the contact list to whom a communication has not been initiated; e) manually activating the control by the calling agent; f) in response to said manual activation, initiating a communication with the first member; g) analyzing the initiated communication to determine a status of the initiated communication; and h) connecting one of the plurality of customer service agents to the initiated communication if it is determined at step (g) that the initiated communication was successful.

In another embodiment, in a contact center having a plurality of customer service agents for participating in communications, a method for initiating communications to members of a contact list is disclosed, the method comprising the steps of: a) selecting a first member from the contact list; b) displaying to a calling agent information about the first member; c) establishing a control that may be activated to initiate a communication with the first member; d) displaying to the calling agent data selected from the group consisting of: number of the plurality of customer service agents available, number of communications connected to any one of the plurality of customer service agents, number of communications waiting to be connected to any one of the plurality of customer service agents, a status of recently initiated communications, and a number of members on the contact list to whom a communication has not been initiated; and e) manually activating the control by the calling agent.

In a further embodiment, in a contact center having a plurality of customer service agents for participating in communications, a method for initiating communications to members of a contact list is disclosed, the method comprising the steps of: a) selecting a first member from the contact list; b) establishing a control that may be activated to initiate a communication with the first member; c) displaying to the calling agent data selected from the group consisting of: number of the plurality of customer service agents available, number of communications connected to any one of the plurality of customer service agents, number of communications waiting to be connected to any one of the plurality of customer service agents, a status of recently initiated communications, and a number of members on the contact list to whom a communication has not been initiated; and d) manually activating the control by the calling agent.

Other embodiments are also disclosed.

### BRIEF DESCRIPTION OF THE DRAWINGS

FIG. 1 is a schematic block diagram of a communications system including a communications handling center, exemplary of one embodiment of the present invention;

FIG. 2 is a schematic block diagram illustrating exemplary organization of memory in the communications handling center illustrated in FIG. 1;

FIG. 3 illustrates an exemplary organization of a system of record database illustrated in FIG. 1;

FIG. 4 illustrates an exemplary organization of the internal communications system call list illustrated in FIG. 1;

FIG. 5 is a schematic flowchart illustrating one embodiment of steps that may be performed by the communications center of FIG. 1;

FIGS. 6A-C illustrate screenshots of certain applications presented by the communications center of FIG. 1; and

FIG. 7 illustrates a screenshot of certain applications presented by the communications center of FIG. 1.

### DETAILED DESCRIPTION OF THE DISCLOSED EMBODIMENTS

For the purposes of promoting an understanding of the principles of the invention, reference will now be made to the embodiment illustrated in the drawings, and specific language will be used to describe that embodiment. It will nevertheless be understood that no limitation of the scope of the invention is intended. Alterations and modifications in the illustrated systems and methods, and further applications of the principles of the invention as illustrated therein, as would normally occur to one skilled in the art to which the invention relates are contemplated, are desired to be protected. Such alternative embodiments require certain adaptations to the embodiments discussed herein that would be obvious to those skilled in the art.

Although the various embodiments disclosed herein will be described in the context of a telephony contact center interconnected with the public switched telephony network (“PSTN”), a person skilled in the art will appreciate that the invention may be used in analogous communications handling centers. For example, the invention may be used as part of a Voice-over-Internet-Protocol (“VoIP”) communications server connected with a packet switched data network; as part of an internet multimedia message response center; as part of an electronic mail response center; a facsimile server; a web chat response center; a social media response center, or the like.

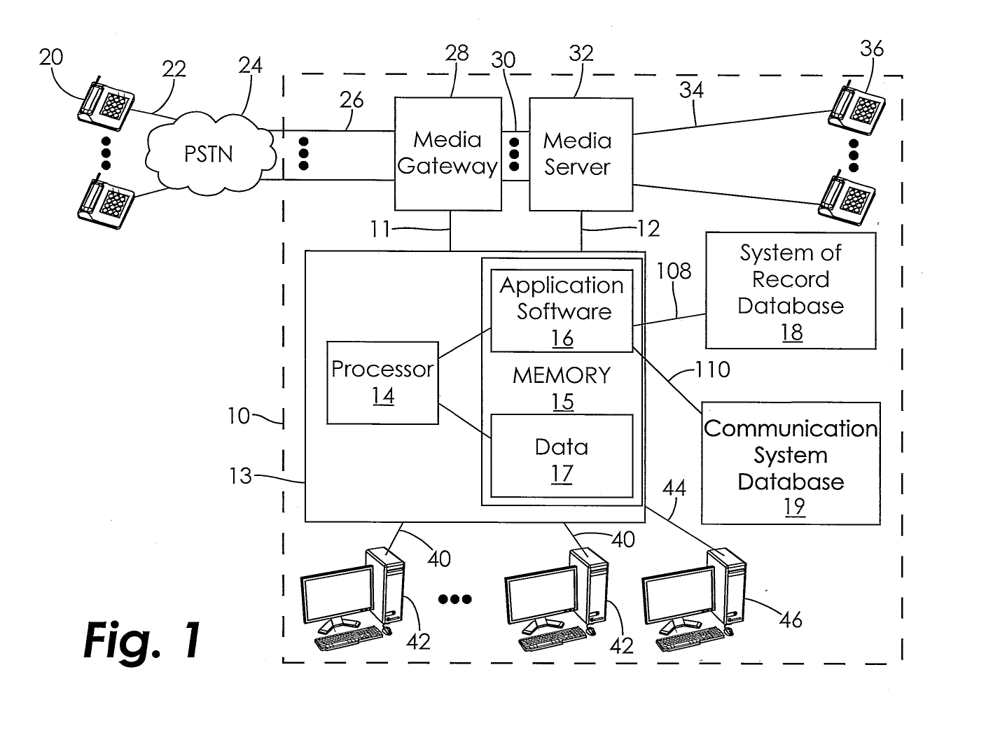

FIG. 1 accordingly illustrates a contact center 10 acting as an automated communications handling center, exemplary of one embodiment of the present invention. Example contact center 10 comprises a communications server 13, a media gateway 28 interconnected to server 13 by link 11, and a media processing server 32 processing call audio for calls connected to media gateway 28 by link 30 and to communications server 13 by link 12. Media processing server 32 processes call audio for calls connected to media gateway 28. One or more customer service agent terminals 42 are provided and are interconnected by links 40 to server 13. One or more calling agent terminals 46 are provided and are interconnected by links 44 to server 13. One or more customer service agent voice endpoints 36 are interconnected to media processing server 32 by link 34. Call center server 13 can access a system of record database 18 via system of record database connector software 108, and can also access the communication system database 19 via communication system database connector software 110. Media gateway 28 (and hence call center 10) is further interconnected with the PSTN 24 by telephone trunks 26. Callers having conventional telephones 20 or similar equipment are also interconnected with the PSTN 24 by telephone lines 22.

In one embodiment, communications server 13 may be, as one non-limiting example, an Interactive Intelligence Customer Interaction Center (available from Interactive Intelligence, Inc., 7601 Interactive Way, Indianapolis, Ind. 46278), adapted in accordance with the presently disclosed embodiments. As such, communications server 13 may be a conventional microprocessor based computing device, such as a conventional X86 based computer. Media Server 32 may similarly be a conventional Interactive Intelligence Media Server (available from Interactive Intelligence, Inc., 7601 Interactive Way, Indianapolis, Ind. 46278), with one or more of these devices acting as a scalable audio processing resource, controlled by the communications server 13. Media gateway 28 may similarly be a conventional TDM to VoIP-SIP gateway such as an AudioCodes Mediant 1000 (available from AudioCodes Ltd., 1 Hayarden Street, Airport City Lod, Israel 70151). It will be appreciated by those skilled in the art that media gateway 28 can alternatively be replaced with any other suitable telephony gateway or carrier VoIP service which would connect the call center 10 to the PSTN 24 without the requirement of a gateway.

As further illustrated in FIG. 1, communications server 13 comprises a processor 14 interconnected with computer readable memory 15. Also interconnected with processor 14 are one or more interfaces (some not illustrated), permitting server 13 to communicate with customer service agent terminals 42, media gateway 28, media processing server 32, system of record database 18, and communications system database 19. Processor 14 is preferably a conventional microprocessor, such as an INTEL X86 family microprocessor, while memory 15 is any suitable combination of RAM, ROM, or other solid state, magnetic, optical or other type of memory. As detailed below, memory 15 stores computer operating system software, application software 16, and data 17, adapting an otherwise conventional computing device to act as communications server 13.

Customer service agent terminals 42 are also preferably conventional computing devices such as INTEL X86 based computers, comprising one or more conventional operator input devices such as a keyboard, mouse, and display. Most preferably, terminals 42 are capable of presenting users, typically contact center customer service agents, a graphical user interface (“GUI”), displaying communications server statistics, call details, and buttons, and allowing contact center 10 interactions to be received. Accordingly, each terminal 42 may store and execute client versions of software, running under a computer operating system, for example, MICROSOFT WINDOWS 7, for providing a suitable GUI. Alternatively, terminals 42 could be conventional terminal service-based displays such as CITRIX XENAPP 6.0 (available from Citrix Systems, Inc., 851 West Cypress Creek Road, Ft. Lauderdale, Fla. 33309), or the like.

Customer service agents are stationed at customer service agent voice endpoints 36, in order to process communications (e.g. telephone calls) routed to the customer service agent voice endpoints 36. Thus, customer service agent voice endpoints 36 may be conventional or VoIP based telephones. Typically, customer service agent voice endpoints 36 are paired with customer service agent terminals 42 for displaying call related information as discussed herein. Calling agent terminals 46 allow for the placement of calls to telephone numbers on a predetermined contact list. As described in greater detail hereinbelow, calling agent terminals 46 allow a human calling agent to manually place calls while reviewing data regarding the number of calls that are currently being handled by the customer service agents or waiting in queues to be handled by the customer service agents.

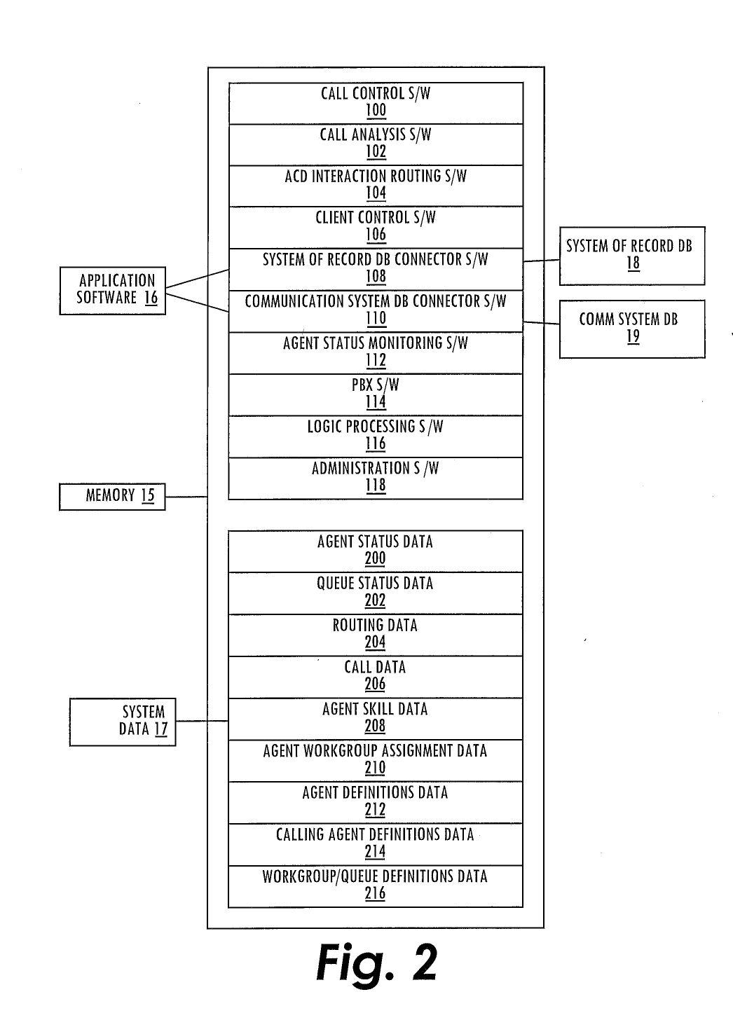

FIG. 2 illustrates an example organization of software blocks or routines forming part of application software 16 within memory 15 and data 17 resulting from, or used to control, application software 16. A machine executable version of application software 16 is stored within memory 15. Additionally, an executable version of a suitable operating system software, such as Microsoft Windows Server 2008, may also be stored within memory 15, but is not illustrated in the diagram.

Application software 16 may be formed using programming techniques, development tools and libraries known to those skilled in the art. As illustrated, exemplary application software 16 may be organized in functional blocks including call control software 100; call analysis software 102; Automatic Call Distributor (ACD) interaction routing software 104; client control software 106; system of record database connector software 108; communications system database connector software 110; agent status monitoring software 112; PBX call switching software 114; other logic processing software 116; and administration software 118. Application software 16 adapts communications server 13 to function in accordance with methods exemplary of the present invention.

As such, application software 16 maintains data 17 within memory 15. Data 17 includes customer service agent status (current) data 200; queue status (current) data 202; call routing data 204; call data 206; customer service agent skill data 208; customer service agent workgroup assignment data 210; customer service agent definitions data 212; calling agent definitions data 214; and workgroup/queue definitions data 216. Data 200, 202, 204, 206, 208, 210, 212, 214, and 216 are typically data sets or structures created and maintained by application software 16 within memory 15. Additionally, data 200, 202, 204, 206, 208, 210, 212, 214, and 216 may be displayed as required at customer service agent workstations 42 and/or calling agent workstations 46, and may be modified within administration software 118.

Customer service agent status data 200 is typically a data set that is dynamically updated by customer service agent input via terminal 42, and has entries for each customer service agent, such as an indication of the presence of that customer service agent (e.g., whether that customer service agent is currently available to be contacted or is currently occupied with a communication), how long the customer service agent has been working on the current communication, and/or any other relevant customer service agent statistics, as will be appreciated those skilled in the art in the art in view of the present disclosure.

Queue Status data 202 is similarly a data set, with dynamically updated entries, such as indicating how many (if any) calls are currently waiting in a particular queue, the length of time calls have been held, and/or any other information relevant to queue status, as will be appreciated by to those skilled in the art in the art in view of the present disclosure. These queues are typically applied to inbound calls, but can also be applied to outbound calls when customer service agents are not available.

Routing data 204 contains data sets defining, for example, routing information for incoming/outgoing communications between the caller endpoint 20 and customer service agent endpoints 36. For example, routing data 204 may show the logical call path for a call routing within the call center 10, describing the call path including the PSTN channel 26, the call identifier for the media gateway 28, the call path 30 between media gateway 28 and media server 32, and the call path 34 between media server 32 and customer service agent voice endpoints 36.

Call data 206 is dynamically updated information about calls or interactions received by the communications server 13, which may include time of call, call length, type of call (interaction type), workgroup queue where call has been routed, caller information, and/or other relevant call information as will be appreciated by those skilled in the art in view of the present disclosure.

Customer service agent skill data 208 contains, for example, definitions of specific skills for each customer service agent. This may include skill level, desire to use various skills, and/or other customer service agent skill information which is used to determine the routing of a call with particular requirements to the appropriate customer service agent to handle that call, as will be appreciated by those skilled in the art in view of the present disclosure.

Customer service agent workgroup assignment data 210 contains, for example, definitions of workgroups, including definition of customer service agent assignment within each workgroup, and/or other customer service agent workgroup assignment information as will be appreciated by those skilled in the art in view of the present disclosure.

Customer service agent definitions data 212 is a data set containing information about customer service agents that may log into the system via the GUI client on terminals 42. This includes, for example, customer service agent name, contact information, permissions, preferences, and other information as will be appreciated by those skilled in the art in view of the present disclosure.

Calling agent definitions data 214 is a data set containing information about calling agents that may initiate the calling agent application GUI client on terminals 46. This includes, for example, calling agent name, contact information, preferences, administrative access to particular workgroups, and any other relevant information as will be appreciated by those skilled in the art in view of the present disclosure.

Workgroup/queue definitions data 216 is a data set defining various call types processed in workgroups/queues at call center 10. One embodiment of the present invention will have a single workgroup to which customer service agents are assigned, with a single queue defined within the workgroup, through which all calls/interactions are routed. Other embodiments will have multiple workgroups and/or queues. The workgroup/queue definitions data set includes, for example, queue names, queue definitions, queue routing information, and other relevant queue definitions as will be appreciated by those skilled in the art in view of the present disclosure.

Call control software block 100 allows communications server 13 to route outbound calls initiated by calling agent workstation 46 using data 17 within memory 15. As described in greater detail hereinbelow, call control software block 100 provides manual click-to-dial buttons as part of the calling agent workstation 46 GUI. These manual click-to-dial buttons display a telephone number pulled from data 17, and the calling agent may initiate a telephone call to this number by clicking a mouse on the associated button on the screen. Those skilled in the art will appreciate from the present disclosure that inputs from the calling agent other than clicking a mouse may be used to initiate the telephone call to the displayed number.

Administration software block 118 is responsible for adapting communications server 13 to present administrator definable system parameters within administrative applications. Administration software block 118 further allows for the variation of data stored within data memory 15 through administrative applications. For example, configuration of administration software 118 allows for the variation of system applications such as call control software 100, call analysis software 102, ACD interaction routing software 104, client control software 106, system of record database connector software 108, communication system database connector software 110, agent status monitoring software 112, PBX software 114, and logic processing software 116. Additionally, administration software 118 may include access to agent status monitoring software 112, which collects and displays real-time and historical data, including customer service agent status data 200, queue status data 202, routing data 204, and call data 206. Furthermore, administration software 118 may allow for variation of data 17 such as customer service agent skill data 208, customer service agent workgroup assignment data 210, customer service agent definitions data 212, calling agent definitions data 214, and workgroup/queue definitions data 216.

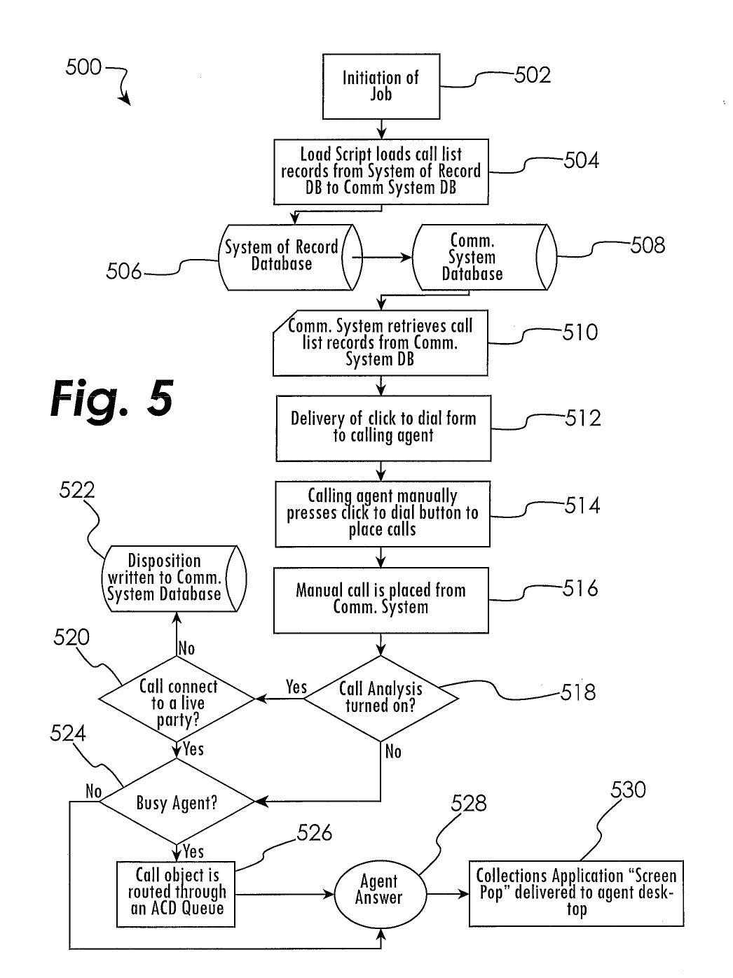

The remaining software blocks shown in FIG. 2 are described in relation to the method of FIG. 5 hereinbelow.

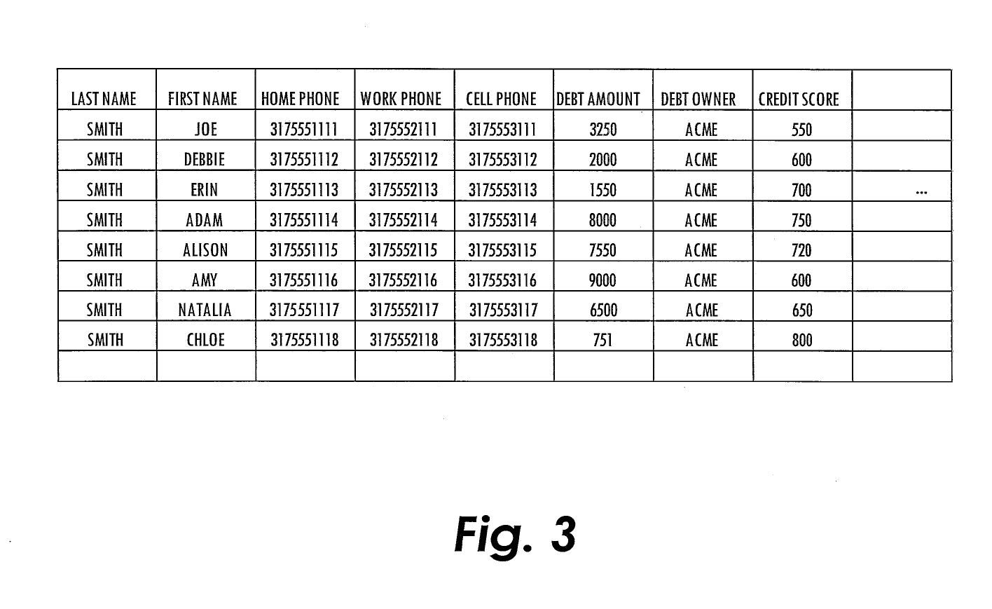

An exemplary organization of a portion of one embodiment of a system of record database 18 is illustrated in FIG. 3. As illustrated, call list contact data 18 may be organized as a two-dimensional array, including rows that may be associated with customer service agents, and with column entries containing data relevant to each contact in the list. For illustration purposes, example rows for only eight contacts are illustrated, where many more contacts may be contained in a true system of record database 18. As illustrated, data 18 may contain for each customer service agent, ASCII or UNICODE data identifying the contact's last name; first name; home telephone number; work telephone number; cellular telephone number; business-relevant information (e.g., debt information for debt collection contact centers); and any other desired information. The system of record database 18 is illustrative of one non-limiting example system of record, to which the server 13 would be allowed access. The example data 18 illustrated in FIG. 3 is not exhaustive, and could contain more or less information relating to each system of record contact without departing from the scope of the present invention.

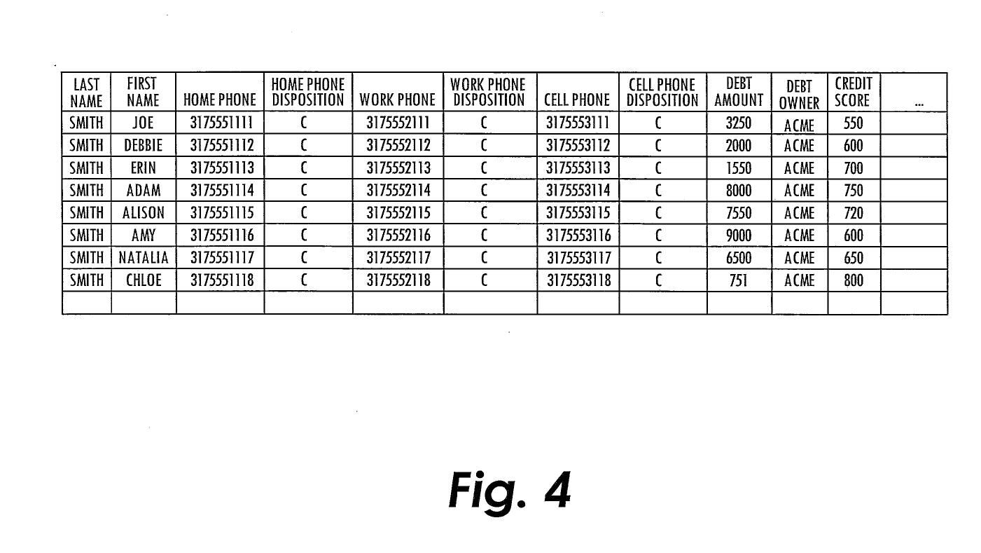

An exemplary organization of a portion of one embodiment of the communications system database 19 is illustrated in FIG. 4. As illustrated, call list contact data 19 may be organized as a two-dimensional array, including rows that may be associated with customer service agents, and with column entries containing data relevant to each contact in the list. For illustration purposes, example rows for only eight contacts are illustrated, where many more contacts may be contained in a true communications system database. The communications system database 19 may be based upon the data in the system of record database 18, with additional data to be described. As illustrated, data 19 preferably contains for each customer service agent, ASCII or UNICODE data identifying the contact's last name; first name; home telephone number; work telephone number; cellular telephone number; business relevant information (e.g., debt information for debt collection contact centers); and any other desired information. As illustrated, the communications system database 19 may also include additional data relevant to the dialing process, such as disposition of calls placed to each telephone number. The communications system database 19 is illustrative of one non-limiting example communications system database, to which the server 13 would be allowed access. The example data 19 illustrated in FIG. 4 is not exhaustive, and could contain more or less information relating to each contact without departing from the scope of the present invention.

Contrary to conventional automated dialer solutions, the presently disclosed embodiments do not contain a software component which performs automated dialing of the telephone numbers contained in the call list contact data. Instead, dialing of telephone numbers contained in the call list contact data is initiated by manual operation by a calling agent as described in greater detail hereinbelow. However, the solution does retain other useful tools typically found in conventional automated dialer solutions, such as ACD routing software, call analysis, and integration to a system of record database and its own communications system database. Additionally, the present invention also uses additional logic processing tools to replace the automated dialer with a manual click-to-dial (or similar manually-initiated dialing) solution.

In operation, communications server 13 as illustrated in FIG. 1 is configured as described previously, and performs steps 500 illustrated in FIG. 5. Steps 500 are performed when it is desired to contact the individuals on a contact list residing in the system of record database 18. Some steps in the process 500 may be run only once per job, and other steps may be run one or more times per job based on the number of contacts in the contact list, as will be described.

Data for available customer service agents and calling agents, such as customer service agent definitions data 212, calling agent definitions data 214, and workgroup/queue definitions data 216 is pre-defined within memory 15. Available customer service agents are those customer service agents presently at customer service agent workstations 42 and customer service agent voice endpoints 36, and calling agents are presently at workstations 46. Calling agents have the ability to initiate outbound telephone calls. Calling agents may also act as customer service agents in some embodiments. Both customer service agents and calling agents make the communications server 13 aware of their presence by executing a log-in process (or other appropriate action) so that the server is aware of which customer service agents and calling agents are available, and their identity is tied to the workstations 42/46 and voice endpoints 36 they are logged into at the time. Means for accomplishing this are well known in the art.

Upon manual or automatic initiation of a job at step 502, the process continues to step 504 where communications server 13 performs a load script operation which will load contact list records from the system of record database 18 (step 506) to the communications system database 19 (step 508), using system of record database connector 108 and communications system database connector 110 respectively. This load script operation is defined as part of the logic processing software 116. The purpose of the load script operation in the present embodiment is to copy all relevant contact list information from the system of record database 18 to the communications system database 19, and then modify the communications system database 19 to include fields which will store relevant contact call result data for each contact, such as the result (disposition) of a telephone call when the contact was dialed, and other relevant data as will be appreciated by those skilled in the art in view of the present disclosure. Two databases are used in the present embodiment because typically the contact center user has an existing system of record database which cannot be modified, and so a second database, the communications system database 19 (which may be modified) is used, and relevant data is sent between the two databases at desired intervals. In other embodiments, a single database may be used in cases where there is no constraint on modification of the primary system of record database. The communications server may optionally use the communications system database connector software 110 to apply sorting and filtering operations to determine the specific records to be contacted for the present job, and the order in which they are to be contacted.

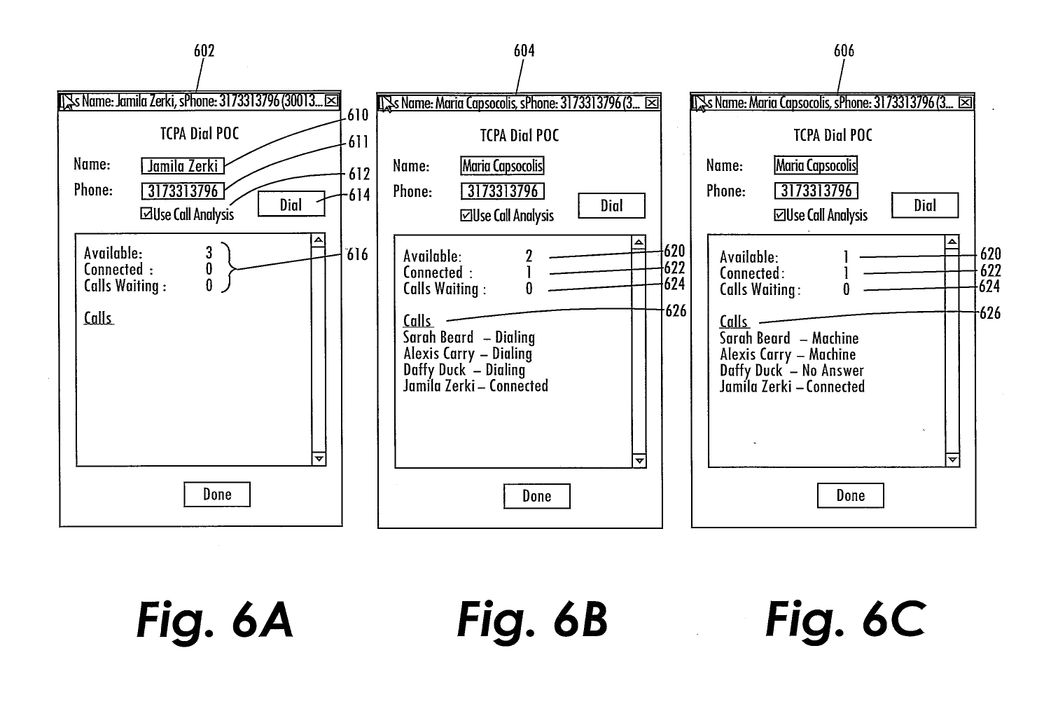

At step 510, the server 13 retrieves the contact list records from the communications system database 19 in order to prepare the system for the placing of calls that are part of the present job. At this point, the communications system database 19 is prepared and the system waits for an agent defined as a calling agent for this job (defined in the calling agent definitions data 214) to log in. When this calling agent logs in, the calling agent has the option to open a click-to-dial form 602, which is presented via the calling agent application GUI on terminal 46, as shown at step 512. As shown in FIGS. 6A-C, form 602 is exemplary of one embodiment of the click-to-dial form, and it displays the following components: a contact name field 610 which will display the name of the next contact in the contact list records from the communications system database 19, a telephone number field 611 that displays the telephone number for the next contact displayed in field 610, a “Use Call Analysis” checkbox 612, a “Dial” button 614, and a dynamic display field 616 using agent status monitoring software 112 to retrieve and display the current customer service agent status data 200, where the “Available” section 620 of display field 616 indicates the number of customer service agents available and ready to take a call. Using ACD interaction routing software 104 to retrieve and display queue status data 202, a “Connected” section 622 of display field 616 indicates the number of calls currently connected to customer service agents. Finally, a “Calls Waiting” section 624 of display field 616 indicates the number of calls the calling agent has dialed, but for which no customer service agents are available to take, and so has been placed in a queue. This data is provided by ACD interaction routing software 104 using queue status data 202. In the present embodiment, the comparison of “Available” customer service agents (field 620) to “Connected” customer service agents (field 622) allows the calling agent to decide if additional calls should be placed, which is done manually using the “Dial” button 614. In the illustrated embodiment, dial button 614 is an area on the GUI of terminal 46 that may be clicked with a mouse. It will be appreciated by those skilled in the art after review of the present disclosure that the dial button 614 may take any form that may be manually actuated by the calling agent, including the non-limiting examples of a touch-activated switch on a touch-sensitive display screen, a voice response unit that receives a verbal command from the calling agent, a manual switch (such as a finger- or foot-operated switch) whose output is sensed by the server 13, or any other convenient form of manually activated input device (it will be appreciated from the foregoing examples that, as used herein, the term “manually” is not limited to activation by a human hand, but also includes other forms of human-controlled activation such as voice command or eye position sensors).

The calling agent that is using the form 602 may manually initiate a telephone call to the contact displayed in field 610 and associated with the telephone number displayed in field 611 by manually clicking the click-to-dial button 614. Once the dial button 614 is activated, the system 10 will dial the telephone number displayed in field 611. As the calling agent continues to place calls using the button 614, the calling agent will see changes dynamically updated in the form. For example, form 604 of FIG. 6B illustrates a possible status once the calling agent has dialed four calls. The Available field 620, indicating number of available customer service agents, has decreased from three in form 602 to two in form 604, reflecting the fact that one of the four calls, shown in the “Calls” field 626, has resulted in connection to a live party at the called end of the telephone line and has been connected to one of the customer service agents who were available at that time to handle a call. The data for Available field 620 is provided by the agent status monitoring software 112 using the customer service agent status data 200. The status of this call is labeled as “Connected” in Calls field 626. Calls field 626 also reflects in FIG. 6B three calls that have been placed by the calling agent (by activating Dial button 614) but which have not yet been answered at the called party location. These calls are labeled as “Dialing.” The Calls Waiting field 624 reflects the fact that there are zero calls which have been answered and are now waiting in queue for an available customer service agent. Form 604 would therefore indicate to the calling agent that two customer service agents are available, and so additional calls can be placed, in hopes of occupying these available customer service agents with connected calls and therefore increasing the efficiency of the contact center. The calling agent may decide to initiate additional calls based upon his experience and the fact that some or all of the current calls that are in the “Dialing” status may be determined to be “No Answer” or “Machine” (i.e., an answering machine was detected at the called end by the system 13 rather than a live person), and the calling agent may decide not to wait for that determination prior to initiating one or more additional telephone calls.

Form 606 of FIG. 6C shows a further example of dynamic changes occurring in the click-to-dial form. The Available field 620 now shows only one customer service agent available, down from two customer service agents in the Available field 620 in form 604. Since the Connected field 622 still shows only one customer service agent connected to a call, this would indicate that one customer service agent must have changed from an available status to an unavailable status, thus lowering the available customer service agent count by one. The Calls waiting field 624 remains at zero, so there are no calls waiting for a customer service agent. Furthermore, the Calls field 626 shows that no calls are in the “Dialing” process, since two of the three calls in the “Dialing” process in form 604 have been answered by an answering machine and one has resulted in no answer. Form 606 would therefore indicate to the calling agent that one customer service agent is available, and so additional calls can be placed, in hopes of occupying this available customer service agent with a connected call and therefore improving the efficiency of the contact center.

In other embodiments, dynamic display field 616 may contain other relevant information which would allow the calling agent to decide whether or not the calling agent needs to initiate more interactions with the Dial button 614. For example, additional information that dynamic display field 616 may show includes data about the next contact to be called from the communication system database 19, including contact name, contact telephone number, the total number of contacts left on the current contact list, or any other information deemed relevant. In certain embodiments, the calling agent also has the option to select or deselect the “Use Call Analysis” checkbox 612, the behavior of which will be described hereinbelow.

Therefore, the calling agent uses the Dial button 614 to initiate a telephone call, as shown as step 514 of FIG. 5. The calling agent can press the Dial button 614 one or more times, and each time the Dial button 614 is pressed, the next contact to be called from the contact list in the communications system database 19 is dialed, shown as step 516.

For each call that is placed in this manner, the communications server 13 will decide whether to use call analysis software 102, based on the state of the “Use Call Analysis” checkbox 612, shown as step 518. If call analysis is turned on, when the phone call is placed, call analysis software 102 will be engaged to determine at step 520 if the call results in connection to a live party which should be delivered to a customer service agent, or if the call is one of many unsuccessful call results such as “no answer” or “answering machine detected” or any other call result which will increase the efficiency of the call center server 13 in routing calls to customer service agents.

If call analysis software 102 analyzes a call at step 520, the call result will be written to the active call data 206 at step 522. The call result will indicate whether the call resulted in connection to a live party, along with any additional call result details. If the call is determined at step 520 to not be connected to a live party, the call result details will be written as a disposition to the communication system database 19 at step 522. However, if the call is connected to a live party per step 520, the call center server 13 will attempt to deliver the call to an available customer service agent.

Delivery to a customer service agent may occur after call analysis is performed and a live party is detected, as shown in step 520, or may occur immediately after a call is placed and call analysis is determined not to be activated, as shown in step 518. In one embodiment, at step 524 the call center server 13 will use agent status monitoring software 112 to query customer service agent status data 200 in order to determine the availability of the calling agent. If the calling agent is not busy, the call will be routed to the calling agent, as shown at step 528. If the calling agent is busy, the call will need to be routed to a customer service agent, and the call will be placed into an ACD queue, shown in step 526. In an alternate embodiment, step 524 may be skipped and all calls will be routed to an ACD queue of customer service agents at step 526, leaving the calling agent to focus on placement of calls only. In this embodiment, the next call in the queue is placed with a customer service agent at step 528 when a customer service agent becomes available.

When a call is placed into an ACD queue at step 526, the call center server 13 will first use ACD interaction routing software 104 to access workgroup/queue definitions data. This data, along with call data 206, will be used to determine the appropriate queue to which the call should be routed. Next, once the call has been routed into a queue, the call center server 13 will use ACD interaction routing software 104, along with agent status monitoring software 112 to access customer service agent status data 200, queue status data 202, customer service agent workgroup assignment data 210, customer service agent definitions data 212 and workgroup/queue definitions data 214. This data will help determine the appropriate customer service agent to whom the call will be routed. Determining factors for routing may include status/presence of customer service agents, algorithms used to determine fair queuing, priority of calls, customer service agent skill data 208, and other factors that will be appreciated by those skilled in the art in view of the present disclosure. In some cases, when there are no customer service agents available, the call may be put on hold, in which case call control software 100 is used to route the call to a media server 32, where queue hold messages and/or music is played.

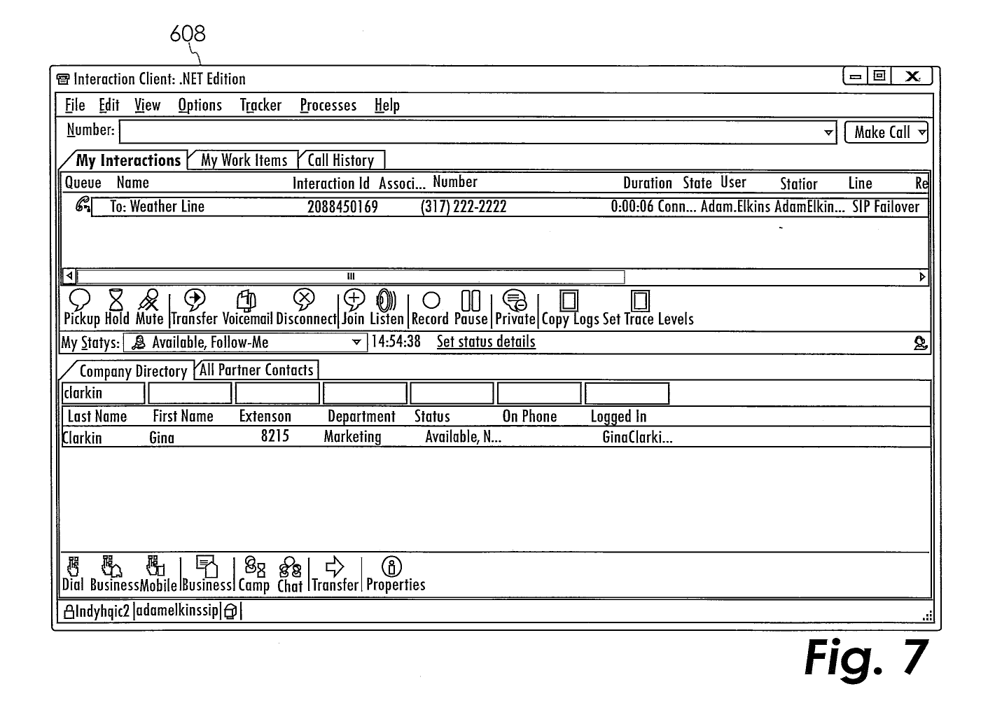

When a customer service agent answers, as shown in step 528, whether the call is delivered to a calling agent or delivered to another customer service agent via ACD, call control software 100 is used to deliver the call to the appropriate customer service agent workstation 42/46. If audio recording, analytics, or other audio manipulation known to those skilled in the art is required, the call audio will be connected from the media gateway 28 to the media server 32, and then from the media server 32 to the customer service agent voice endpoints 36. The number of media gateways can be increased for scalability, as audio processing can require a high amount of resources. At the time the customer service agent picks up the call, the call center server 13 also uses client control software 106 to show relevant call data 206 within a client application 608 (see FIG. 7) on the customer service agent workstation 42/calling agent workstation 46, and to open a collections application, known in the art as a “screen pop,” as shown in step 530.

As can be seen from the above description, the various embodiments allow for the manual initiation of contacts to one or more persons on a contact list. A calling agent decides when the next call should be placed and initiates this call manually by activating a suitable Dial button. Calls which are determined to be favorable for connection to a customer service agent are routed to the next available customer service agent. The calling agent may be given data regarding various factors, including number of available customer service agents and number of calls presently being dialed, in order to provide more accurate bases for deciding when the next call should be initiated. In this way, the calling agent has control over the pace at which calls are initiated and may optimize this pace to maximize the efficiency of the contact center and the use of the customer service agents' time.

While the organization of steps, software blocks, data and data structures have been illustrated as clearly delineated, a person skilled in the art will appreciate that the delineation between steps, blocks and data is somewhat arbitrary. Numerous other arrangements of steps, software blocks and data are possible.

Similarly, as already noted, while the above described embodiments have been described in the context of a telephony contact center interconnected with the PSTN, the invention may be used in analogous communications handling centers. For example, the invention may be used as part of a hosted call center solution; as part of a chat based response center; or the like. In such embodiments, agent stations would accordingly include appropriate equipment, such as multimedia endpoints, or the like, to allow proper agent handling of each incoming communication. Similarly, handling requirements for outgoing communications can be determined in numerous ways, including using information within the communication, including a header accompanying the communication, or its content.

Finally, it will be understood that the invention is not limited to the embodiments described herein which are merely illustrative of several embodiments for carrying out the invention, and which are susceptible to modification of form, arrangement of parts, steps, details and order of operation. The invention, rather, is intended to encompass all such modifications within its spirit and scope, as defined by the claims.

What is claimed is:

1. In a contact center having a plurality of customer service agents for participating in communications, a method for initiating communications to members of a contact list, the method comprising the steps of:
a) selecting a first member from the contact list;
b) displaying to a calling agent information about the first member;
c) establishing a control that may be activated to initiate a communication with the first member;
d) displaying to the calling agent data selected from the group consisting of: number of the plurality of customer service agents available, number of communications connected to any one of the plurality of customer service agents, number of communications waiting to be connected to any one of the plurality of customer service agents, a status of recently initiated communications, and a number of members on the contact list to whom a communication has not been initiated;
e) manually activating the control by the calling agent;
f) in response to said manual activation, initiating a communication with the first member;
g) analyzing the initiated communication to determine a status of the initiated communication; and
h) connecting one of the plurality of customer service agents to the initiated communication if it is determined at step (g) that the initiated communication was successful.

2. The method of claim 1, wherein said information about the first member is selected from the group consisting of: a name of the first member and a communication address of the first member.

3. The method of claim 2, wherein said communication comprises a telephone call and said communication address comprises a telephone number.

4. The method of claim 1, wherein said control comprises a button displayed on a graphical user interface.

5. The method of claim 4, wherein said activation by a calling agent comprises clicking a computer input mouse on said button.

6. The method of claim 1, wherein said control is selected from the group consisting of: a touch-activated switch on a touch-sensitive display screen, a voice response unit responsive to a verbal command from the calling agent, a finger-operated manual switch, a foot-operated manual switch, and an eye position sensor.

7. The method of claim 1, wherein said initiating a communication comprises a computing device dialing a telephone number.

8. The method of claim 3, wherein step (g) comprises determining that the telephone call has a status selected from the group consisting of: dialing, no answer, answered by an answering machine, and answered by a live person.

9. The method of claim 1, wherein said successful communication comprises being answered by a live person.

10. The method of claim 1, wherein said communication is selected from the group consisting of: telephone call, Voice-over-Internet-Protocol communication; an internet multimedia message; an electronic mail; a facsimile; a web chat; and a social media post.

11. In a contact center having a plurality of customer service agents for participating in communications, a method for initiating communications to members of a contact list, the method comprising the steps of:
a) selecting a first member from the contact list;
b) displaying to a calling agent information about the first member;
c) establishing a control that may be activated to initiate a communication with the first member;
d) displaying to the calling agent data selected from the group consisting of: number of the plurality of customer service agents available, number of communications connected to any one of the plurality of customer service agents, number of communications waiting to be connected to any one of the plurality of customer service agents, a status of recently initiated communications, and a number of members on the contact list to whom a communication has not been initiated;
e) manually activating the control by the calling agent; and
f) in response to said manual activation, initiating a communication with the first member.

12. The method of claim 11, wherein said information about the first member is selected from the group consisting of: a name of the first member and a communication address of the first member.

13. The method of claim 12, wherein said communication comprises a telephone call and said communication address comprises a telephone number.

14. The method of claim 11, wherein said control comprises a button displayed on a graphical user interface.

15. The method of claim 14, wherein said activation by a calling agent comprises clicking a computer input mouse on said button.

16. The method of claim 11, wherein said control is selected from the group consisting of: a touch-activated switch on a touch-sensitive display screen, a voice response unit responsive to a verbal command from the calling agent, a finger-operated manual switch, a foot-operated manual switch, and an eye position sensor.

17. The method of claim 11, wherein said initiating a communication comprises a computing device dialing a telephone number.

18. The method of claim 11, further comprising:
g) analyzing the initiated communication to determine a status of the initiated communication; and
h) connecting one of the plurality of customer service agents to the initiated communication if it is determined at step (g) that the initiated communication was successful.

19. The method of claim 18, wherein said communication comprises a telephone call and said communication address comprises a telephone number.

20. The method of claim 19, wherein step (g) comprises determining that the telephone call has a status selected from the group consisting of: dialing, no answer, answered by an answering machine, and answered by a live person.

21. The method of claim 18, wherein said successful communication comprises being answered by a live person.

22. In a contact center having a plurality of customer service agents for participating in communications, a method for initiating communications to members of a contact list, the method comprising the steps of:
a) selecting a first member from the contact list;
b) establishing a control that may be activated to initiate a communication with the first member;
c) displaying to the calling agent data selected from the group consisting of: number of the plurality of customer service agents available, number of communications connected to any one of the plurality of customer service agents, number of communications waiting to be connected to any one of the plurality of customer service agents, a status of recently initiated communications, and a number of members on the contact list to whom a communication has not been initiated;
d) manually activating the control by the calling agent; and
e) in response to said manual activation, initiating a communication with the first member.

22. The method of claim 21, further comprising:
f) displaying to a calling agent information about the first member.

23. The method of claim 22, wherein said information about the first member is selected from the group consisting of: a name of the first member and a communication'address of the first member.

24. The method of claim 23, wherein said communication comprises a telephone call and said communication address comprises a telephone number.

25. The method of claim 21, wherein said control comprises a button displayed on a graphical user interface.

26. The method of claim 25, wherein said activation by a calling agent comprises clicking a computer input mouse on said button.

27. The method of claim 21, wherein said control is selected from the group consisting of: a touch-activated switch on a touch-sensitive display screen, a voice response unit responsive to a verbal command from the calling agent, a finger-operated manual switch, a foot-operated manual switch, and an eye position sensor.

28. The method of claim 11, wherein said initiating a communication comprises a computing device dialing a telephone number.

29. The method of claim 21, further comprising:
f) analyzing the initiated communication to determine a status of the initiated communication; and
g) connecting one of the plurality of customer service agents to the initiated communication if it is determined at step (f) that the initiated communication was successful.

30. The method of claim 29, wherein said communication comprises a telephone call and said communication address comprises a telephone number.

31. The method of claim 30, wherein step (f) comprises determining that the telephone call has a status selected from the group consisting of: dialing, no answer, answered by an answering machine, and answered by a live person.

32. The method of claim 29, wherein said successful communication comprises being answered by a live person.
